(19) United States
(12) Patent Application Publication
(10) Pub. No.: US 2026/0210006 A1
(43) Pub. Date: Jul. 23, 2026

(54) MANUFACTURE OF A BLADE REINFORCING ELEMENT, WITH PRE-COMPACTION

(71) Applicants: SAFRAN AIRCRAFT ENGINES, PARIS (FR); SAFRAN, PARIS (FR)

(72) Inventors: Celia IGLESIAS CANO, MOISSY-CRAMAYEL (FR); Manon COMMARMOT, MOISSY-CRAMAYEL (FR); Julien GEORGES, MOISSY-CRAMAYEL (FR)

(21) Appl. No.: 19/138,484

(22) PCT Filed: Dec. 7, 2023
(86) PCT No.: PCT/FR2023/051956

§ 371 Date: Jun. 12, 2025

(30) Foreign Application Priority Data
Dec. 14, 2022 (FR) FR2213319

(51) Int. Cl. D03D 25/00; C08J 5/24; D06C 15/00; F01D 5/28

(52) U.S. Cl. CPC D03D 25/005; C08J 5/24; D06C 15/00; F01D 5/282; D10B 2505/02; F05D 2230/10

(57) ABSTRACT

A method for manufacturing a fibrous preform of a reinforcing element for a turbine engine blade, includes producing a fibrous blank by three-dimensional weaving between a plurality of warp yarns and a plurality of weft yarns, pre-compacting the fibrous blank in a pre-compaction tool, removing a raw surface of the fibrous blank by water-jet cutting while the fibrous blank is being pre-compacted in the pre-compaction tool, removing the pre-compacted fibrous blank from the pre-compaction tool, compacting the pre-compacted fibrous blank in order to obtain the fibrous preform of the reinforcing element.

### TECHNICAL FIELD

The present invention relates to a reinforcing element for a composite blade of a turbine engine or propeller engine. The composite blade may, for example, be a fan blade or an outlet guide vane, known as an “OGV”.

### PRIOR ART

In order to obtain lightweight turbine engine blades with excellent thermomechanical properties, the blades are made in a well-known manner from a composite material, that is to say from a material comprising a fibrous reinforcement densified by a matrix, for example an organic matrix. Furthermore, the non-structural parts of the blades can be hollow in order to further reduce their mass.

Document FR 3 063 514 A1 describes an example of a rectifier blade of a ducted turbine engine extending radially between an internal platform, by which the blade is fixed to an internal casing of the turbine engine, and an external platform, by which the blade is fixed to an external casing of the turbine engine. The fiber reinforcement of the vane body of the blade has an end part comprising two segments separated from each other up to a free end. The blade further comprises an insert, called a “gap filler” or “roving”, allowing to fill the empty space at the junction between the two separated segments. Such an insert can in particular be manufactured using a shaped braid.

Such turbine engine blades may belong, for example, to a dual-flow turbine engine, in which the air mass drawn in by the fan is divided in a well-known manner between a primary flow and a secondary flow. The bypass ratio of a turbine engine corresponds to the ratio between the primary flow rate and the secondary flow rate. In order to improve the performance of the turbine engine and reduce its fuel consumption, it is beneficial to increase this bypass ratio. However, such an increase in the bypass ratio requires increasing the blade height, particularly the fan blades and the associated rectifier blades, to maintain a similar engine thrust. This increase in height is even more significant for unducted turbine engines, in which the blades are already large and the rotational speeds are lower.

Thus, the insert as described above must meet the new geometric and structural constraints of these new blades. The insert must therefore have a more elongated and flared shape, and a more abrupt variation in thickness to adapt to the new blade geometries. However, such a shape is not achievable using known techniques, including with inserts made from a braid.

Furthermore, in unducted turbine engines, attaching the blade, in particular a rectifier blade, to a turbine engine casing only by its internal radial end located at the blade root results in all the forces being transmitted to the blade root area, which results in high stress levels in the composite parts of the blade root. Known inserts do not allow the blade root area to be sufficiently reinforced locally, and thus do not sufficiently limit the opening and stresses at the separated segments of the fiber reinforcement under tensile, compressive and bending stresses. Furthermore, known inserts made from a braid have too low a stiffness and therefore do not allow the overall stiffness of the blade to be sufficiently increased, which leads to an increased risk of buckling and a deterioration in the frequency placement of the rectifier.

### DISCLOSURE OF THE INVENTION

In order to overcome the aforementioned disadvantages, the invention proposes the manufacture of a reinforcing element allowing to fulfill, on the one hand, the function of the insert known from the prior art and, on the other hand, to fulfill a spar function, even when said reinforcing element has a very flared geometry.

To this end, the invention proposes a method for manufacturing a fibrous preform of a reinforcing element for a blade, for example of a turbine engine, comprising the following steps:
producing a fibrous blank by three-dimensional weaving between a plurality of warp yarns extending in a first direction and a plurality of weft yarns extending in a second direction intersecting, for example perpendicular, to the first direction, the fibrous blank extending in the first direction between a reference surface and a raw surface, and extending in a third direction intersecting, for example perpendicular, to the first and second directions between two surfaces to be profiled,
removing the raw surface of the fibrous blank by water-jet cutting so as to produce a clean surface,
arranging the fibrous blank comprising the clean surface in a compaction tool in order to obtain a fibrous preform having the shape of the reinforcing element to be obtained and having a determined volumetric fiber content;

the method being characterized in that it further comprises:
arranging the fibrous blank in a pre-compaction tool before removing the raw surface of said blank, the pre-compaction tool comprising a housing delimited by a base and two jaws extending from said base, the spacing between the two jaws being adjustable, the fibrous blank being arranged in the housing of the pre-compaction tool so that the reference surface of said blank is arranged in contact with the base, then
adjusting the jaws of the pre-compaction tool so that the housing of the pre-compaction tool has the shape of the fibrous preform of the reinforcing element to be obtained in order to pre-compact the fibrous blank, the surfaces to be profiled of the blank being arranged in contact with the jaws and the raw surface of the fibrous blank being free;

the step of removing the raw surface being carried out while the fibrous blank is being pre-compacted in the pre-compaction tool, and the pre-compacted fibrous blank being removed from the pre-compaction tool after the step of removing the raw surface before being arranged in the compaction tool.

Thus, the preform of the reinforcing element is produced by three-dimensional weaving of fibers, which allows to obtain a reinforcing element with excellent rigidity, in particular in the radial direction relative to the engine axis of the turbine engine. Furthermore, the interface between the three-dimensional weaving of the reinforcing element and the three-dimensional weaving of the rest of the blade is more robust.

By cutting the fibrous blank of the reinforcing element while it is pre-compacted, the precision of the cutting is greatly increased, which allows to produce more complex reinforcing element shapes that are more adaptable to new generation blades. Indeed, if the cutting were carried out in a conventional manner without pre-compaction, this step would cause a deformation of the fibrous blank during cutting, and the clean surface thus obtained would itself be deformed and far from the desired geometry.

The fibrous blank may be pre-compacted so as to obtain a flared shape at the clean surface. The fibrous preform of the reinforcing element may have a flared shape. The thickness of the fibrous preform of the reinforcing element along the third direction D₃ may increase by at least 200% over a distance of less than 50% along the first direction D₁ of the length of said reinforcing element preform.

According to a particular embodiment of the invention, the fibrous blank is obtained by water-jet cutting in a fibrous strip produced by three-dimensional weaving at the outlet of a loom.

According to another particular embodiment of the invention, the reference surface and the raw surface of the fibrous blank comprise the same number of warp yarns.

Thus, the fibrous blank is produced without the warp yarns emerging: it is therefore simpler and quicker to produce, and limits the risk of a defect appearing in said blank after cutting the emerging yarns.

According to another particular embodiment of the invention, the fibrous blank comprises a first portion extending from the reference surface having a compacting capacity greater than the compacting capacity of a second portion of the blank extending from the raw surface.

According to another particular embodiment of the invention, the average diameter of the weft yarns of the second portion of the blank is larger than the average diameter of the weft yarns of the first portion of said blank.

According to another particular embodiment of the invention, the water-jet cutting for removing the raw surface follows a non-rectilinear profile.

According to another particular embodiment of the invention, the fibrous blank is arranged in the pre-compaction tool so that two raw lateral surfaces of the fibrous blank opposite in the second direction are free, the two raw lateral surfaces being removed by water-jet cutting while the fibrous blank is being pre-compacted in the pre-compaction tool.

Thus, it is also possible to perform the cutting of two raw lateral surfaces in the same step as the cutting of the raw surface. It is thus possible to better control the shape of the lateral surfaces of the preform.

The invention further relates to a method for manufacturing a blade made of composite material comprising the following steps:
manufacturing a fibrous preform of a reinforcing element as described previously,
manufacturing a fibrous preform of the blade comprising at least two skins connected to each other at one end and delimiting there between a cavity opening into an opening,
inserting all or part of the fibrous preform of the reinforcing element into the cavity of the fibrous blank of the blade so as to fill the opening of said cavity,
densifying, by a matrix, the assembly formed by the fibrous preform of the reinforcing element arranged in the fibrous preform of the blade, so as to obtain a blade made of composite material comprising a reinforcing element.

According to a particular embodiment of the invention, a filling element is inserted at the base of the cavity of the fibrous preform of the blade before the fibrous preform of the reinforcing element is inserted into said cavity.

The filling element preferably has a density lower than the density of the reinforcing element and blade preforms, which allows to reduce the mass of the final blade.

According to a particular embodiment of the invention, the blade is a stator blade. The blade may also be a rotor blade or a propeller blade.

Indeed, such a blade configuration is particularly suitable for a fixed blade.

The invention also relates to a blade obtained by the manufacturing method described above, the thickness of the reinforcing element of the blade obtained increasing by at least 200% over a distance less than 50% of the height of said reinforcing element.

The invention finally relates to a turbine engine comprising at least one blade as described previously.

### BRIEF DESCRIPTION OF THE DRAWINGS

FIG. 1 is a partial schematic perspective view of a fibrous web made by three-dimensional weaving.

FIG. 2 is a schematic perspective view of a fibrous blank of a reinforcing element.

FIG. 3 is a schematic perspective view of a pre-compaction tool.

FIG. 4 is a schematic sectional view of the fibrous blank of FIG. 2 arranged in the pre-compaction tool of FIG. 3.

FIG. 5 is a schematic top view of the fibrous blank of FIG. 2 arranged in the pre-compaction tool of FIG. 3.

FIG. 6 is a schematic perspective view of the fibrous blank of FIG. 2 pre-compacted with the tool of FIG. 3.

FIG. 7 is a schematic top view of a fibrous blank arranged in a pre-compaction tool according to a variant of the invention.

FIG. 8 is a schematic perspective view of the pre-compacted fibrous blank of FIG. 7.

FIG. 9 is an exploded schematic view of the arrangement of the pre-compacted fibrous blank of FIG. 6 in a compaction tool.

FIG. 10 is a schematic sectional view of a fibrous preform of the reinforcing element inserted into a fibrous preform of the blade.

### DESCRIPTION OF THE EMBODIMENTS

The invention applies generally to the production of a turbine engine blade or vane made of composite material, which comprises a reinforcing element.

The invention finds an advantageous application for stator blades, called fixed blades, for example for rectifier blades. The blade obtained by the method of the invention may be an OGV type distributor blade, for “outlet guide vane”, in the case of a ducted engine. The blade obtained by the method of the invention may also be a stator blade of an unducted engine. The blade obtained by the method of the invention may thus be a blade of a UDF type turboprop comprising two unducted and counter-rotating fans, or of a USF type turboprop comprising a single unducted fan and a rectifier.

The manufacturing method according to the invention comprises producing a fibrous blank of the reinforcing element. The fibrous blank of the reinforcing element is intended to be shaped to obtain a fibrous preform of the reinforcing element. The fibrous preform of the reinforcing element is intended to form the fibrous reinforcement of the reinforcing element.

According to a particular embodiment of the invention, the fibrous blank is obtained by trimming in a fibrous strip. The trimming of the fibrous blank in the fibrous strip can be carried out by water-jet cutting.

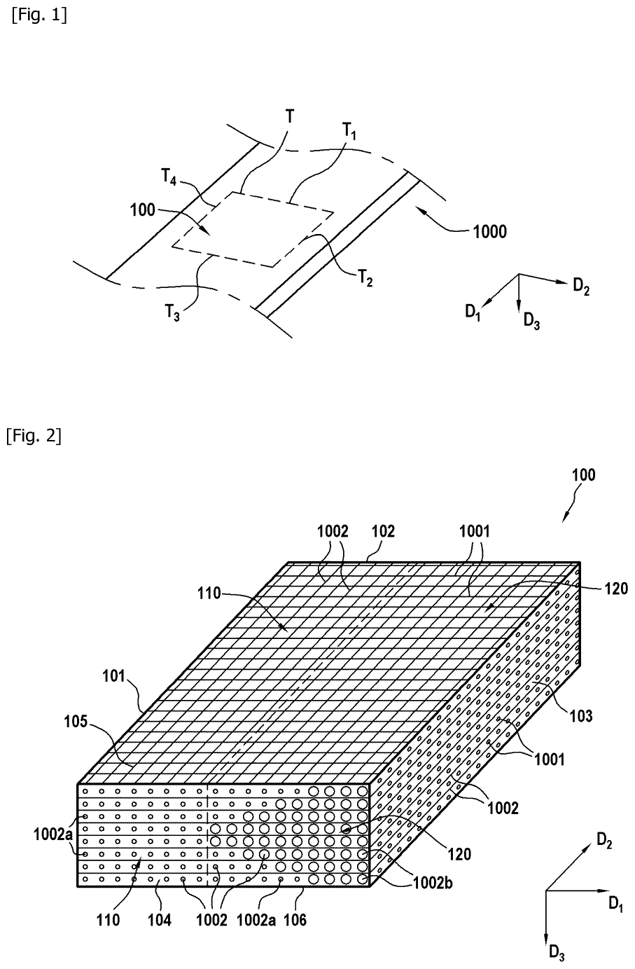

FIG. 1 illustrates an example of a fibrous strip 1000 allowing a fibrous blank 100 of a reinforcing element to be obtained.

The fibrous web 1000 is produced by three-dimensional weaving between a plurality of warp yarns and a plurality of weft yarns. The fibrous web 1000 can be produced in a well-known manner using a Jacquard type loom. “Three-dimensional weaving” means here a weaving method by which at least some of the warp yarns bind weft yarns on several weft layers. It is considered that a fibrous web or a fibrous blank produced by three-dimensional weaving can comprise another type of weaving on its surface, for example two-dimensional weaving, in order to improve its surface condition. The fibrous web or the fibrous blank can for example have a three-dimensional weaving pattern of the interlock or multisatin type. Different three-dimensional weaving methods that can be used are described in document WO 2006/136755.

The warp yarns of the fibrous strip 1000 extend generally in a first direction D₁ and the weft yarns of the fibrous strip 1000 extend generally in a second direction D₂ perpendicular to the first direction D₁. Thus, the fibrous strip 1000 extends longitudinally in the first direction D₁ and transversely in the second direction D₂. The fibrous strip 1000 extends in thickness in a third direction D₃ perpendicular to the first direction Di and to the second direction D₂.

The cutting of the fibrous blank 100 inside the fibrous strip 1000 can be carried out in a well-known manner by water-jet cutting. The fibrous blank 100 is cut out in the fibrous strip 1000 along a determined cutting path T. Preferably, to facilitate cutting in the fibrous strip 1000, the path T has a rectangular shape as illustrated in FIG. 1. In order to obtain an advantageous orientation of the fibers in the fibrous blank 1000 of the reinforcing element, the path T can be made up of straight lines T₁, T₂, T₃ and T₄ directed along the first direction Di or along the second direction D₂, that is to say directed along the warp and weft directions. In the example illustrated in FIG. 1, the longitudinal lines T₂ and T₄ of the path T extend along the first direction D₁ and the transverse lines T₁ and T₃ of the path T extend along the second direction D₂.

Several fibrous blanks of reinforcing element can be cut out from the same fiber strip.

The fibrous blank 100 thus cut out is illustrated schematically in FIG. 2. The fibrous blank 100 extends in the first direction Di between a reference surface 101 and a raw surface 103. In the example illustrated in FIGS. 1 and 2, the reference surface 101 was obtained by cutting the fibrous strip 1000 along a transverse straight line T₁ of the path T, and the raw surface 103 was obtained by cutting the fibrous strip 1000 along a transverse straight line T₃ of the path T. The fibrous blank 100 extends in the second direction D₂ between a first lateral surface 102 and a second lateral surface 104. In the example illustrated in FIGS. 1 and 2, the first lateral surface 102 was obtained by cutting the fibrous strip 1000 along a longitudinal straight line T₂ of the path T, and the second lateral surface 104 was obtained by cutting the fibrous strip 1000 along a longitudinal straight line T₄ of the path T. The fibrous blank 100 extends along the third direction D₃ between a first surface to be profiled 105 and a second surface to be profiled 106. The surfaces to be profiled 105 and 106 of the fibrous blank 100 are preferably flat in order to facilitate their manufacture, that is to say they extend in a plane along the first and second directions D₁ and D₂.

The blank is thus produced by three-dimensional weaving between a plurality of warp yarns 1001 and a plurality of weft yarns 1002. The fibrous blank 100 may comprise a plurality of yarns or filaments of various types, in particular ceramic or carbon yarns or a mixture of such yarns. Preferably, the fibrous blank may be produced from silicon carbide fibers. Generally, the fibrous blank may also be produced from fibers made of the following materials: alumina, mullite, silica, an aluminosilicate, a borosilicate, carbon, or a mixture of several of these materials.

The fibrous blank 100 is preferably produced without the layers of warp yarns 1001 emerging in order to facilitate its production, that is to say that all the warp yarns 1001 of the fibrous blank 100 extend from the reference surface 101 to the raw surface 103, without warp yarns emerging through the surfaces to be profiled 105 and 106.

The fibrous blank 100 comprises a first portion 110 extending from the reference surface 101 along the first direction D₁, and extending over the entire length of the fibrous blank 100 between the two lateral surfaces 102 and 104. Thus, the first portion 110 comprises the reference surface 101 and a portion of the two lateral surfaces 102 and 104. The first portion 110 does not comprise the raw surface 103. The fibrous blank 100 further comprises a second portion 120 extending from the raw surface 103 along the first direction D₁, and extending over the entire length of the fibrous blank 100 between the two lateral surfaces 102 and 104. Thus, the second portion 120 comprises the raw surface 103 and a portion of the two lateral surfaces 102 and 104. The second portion 120 does not comprise the reference surface 101.

Preferably, the first portion 110 of the fibrous blank 100 has a greater compacting capacity than the compacting capacity of the second portion 120 of the fibrous blank 100. The first portion 110 may have a greater expansion than the second portion 120. The difference in compacting capacity between the first portion 110 and the second portion 120 may be achieved in various ways known to the person skilled in the art. For example, the variation in compacting capacity may be achieved by using weft yarns of different diameters. Thus, the weft yarns of the first portion 110 of the fibrous blank 100 may have a smaller average diameter than the average diameter of the weft yarns of the second portion 120. Preferably, in order to produce the desired particular shape of the reinforcing element, the fibrous blank 100 has an average diameter of the weft yarns gradually increasing along the first direction Di from the reference surface 101 towards the raw surface 103. Each column of weft yarns of the fibrous blank 100 may have the same number of weft yarns, the columns of weft yarns each extending along the third direction D₃.

The fibrous blank 100 may be formed by a plurality of first weft yarns 1002a having a first diameter and by a plurality of second weft yarns 1002b having a second diameter, the second diameter being greater than the first diameter. Thus, the weft yarns of the first portion 110 of the fibrous blank 100 may be only first weft yarns 1002a, while the second portion 120 of the fibrous blank 100 may comprise second weft yarns 1002b. In this configuration, if it is desired to progressively increase the average diameter of the weft yarns along the first direction Di from the reference surface 101 towards the raw surface 103, it is possible to progressively increase the proportion of second weft yarns 1002b in each column of weft yarns. Of course, it does not go beyond the scope of the invention if the fibrous blank is formed by weft yarns having more than two different diameters.

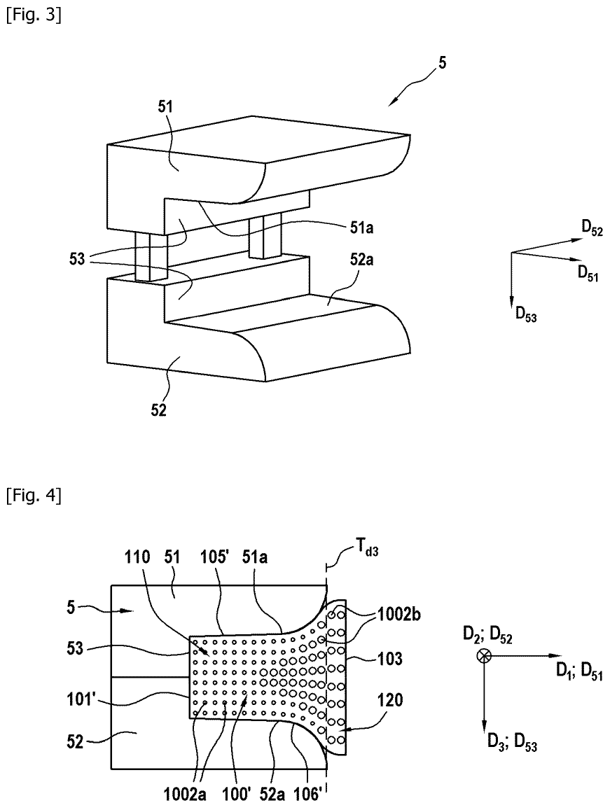

The fibrous blank 100 is then placed in a pre-compaction tool 5. An example of such a pre-compaction tool is illustrated in FIG. 3.

The pre-compaction tool 5 comprises a first jaw 51 and a second jaw 52 arranged opposite each other. In particular, the first jaw 51 comprises a contact surface 51a arranged opposite a contact surface 52a of the second jaw 52. The jaws 51 and 52 may be made of metal, for example steel. The jaws 51 and 52 extend generally in a first direction D₅₁ and in a second direction D₅₂ perpendicular to the first direction D₅₁. The contact surfaces 51a and 52a of the two jaws 51 and 52 may have an identical geometry, that is to say they are symmetrical. The contact surfaces 51a and 52a of the two jaws 51 and 52 may have a different geometry.

The pre-compaction tool 5 further comprises a base 53. The base 53 extends in the second direction D₅₂ and in a third direction D₅₃ perpendicular to the first and second directions D₅₁ and D₅₂. The two jaws 51 and 52 extend from the base 53 in the first direction D₅₁.

The jaws 51 and 52 are spaced from each other along the third direction D₅₃. The spacing between the two jaws 51 and 52 along the third direction D₅₃ is adjustable. Thus, the two jaws 51 and 52 are movable in translation relative to each other along the third direction D₅₃. The volume delimited by the base 53 and the jaws 51 and 52 defines a pre-compaction housing.

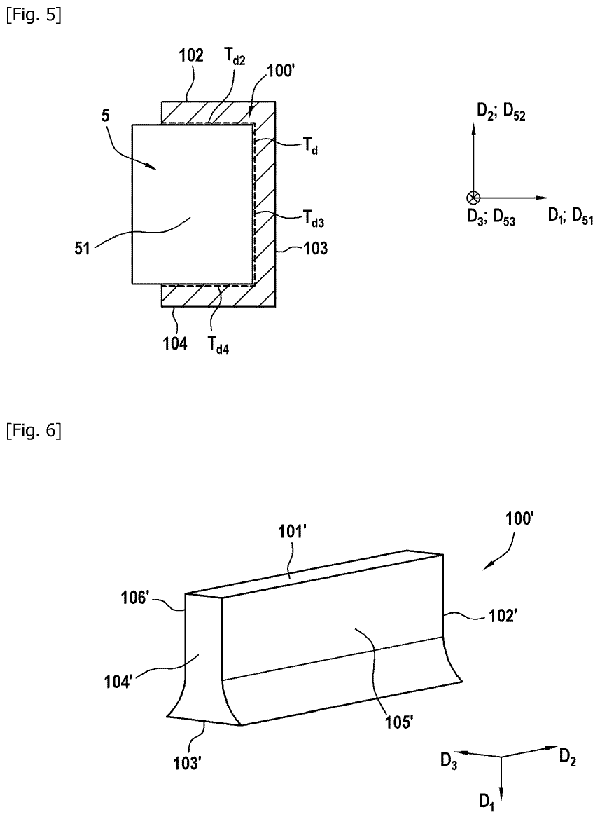

The fibrous blank 100 can be arranged in the pre-compaction tool 5 so that the first, second and third directions D₁, D₂ and D₃ of the fibrous blank 100 coincide respectively with the first, second and third directions D₅₁, D₅₂ and D₅₃ of the pre-compaction tool 5, as in the example illustrated in FIGS. 4 and 5.

The fibrous blank 100 is arranged in the pre-compaction tool 5 so that the reference surface 101 of said fibrous blank 100 is in contact with the base 53 of the pre-compaction tool 5. The reference surface 101 is thus present between the two jaws 51 and 52 of the pre-compaction tool 5. However, the reference surface 101 may have one or more portions which protrude from the jaws 51 and 52 in the second direction D₂, D₅₂ when the fibrous blank 100 is arranged in the pre-compaction tool 5, as in the example illustrated in FIG. 5. The reference surface 101 may also be entirely present between the two jaws 51 and 52 when the fibrous blank 100 is arranged in the pre-compaction tool 5.

The spacing between the jaws 51 and 52 is adjusted so that the jaws 51 and 52 are in contact with the surfaces to be profiled 105 and 106. When the fibrous blank 100 is arranged in the pre-compaction tool 5, the raw surface 103 is free, that is to say it is not present between the jaws 51 and 52. The lateral surfaces 102 and 104 each have at least one portion which protrudes from the jaws 51 and 52 in the first direction D₁, D₅₁ when the fibrous blank 100 is arranged in the pre-compaction tool 5, as illustrated in FIGS. 4 and 5. The lateral surfaces 102 and 104 of the fibrous blank 100 may be present between the jaws 51 and 52 when the fibrous blank 100 is arranged in the pre-compaction tool 5. The lateral surfaces 102 and 104 may also each have at least one portion which protrudes from the jaws 51 and 52 in the second direction D₂, D₅₂ when the fibrous blank 100 is arranged in the pre-compaction tool 5, as illustrated in FIG. 5. In this configuration, at least one of the lateral surfaces 102 or 104 may be free. Both lateral surfaces 102 and 104 may be free when the fibrous blank 100 is arranged in the pre-compaction tool 5. In this configuration, the lateral surfaces 102 and 104 are called raw lateral surfaces.

The spacing between the jaws 51 and 52 is adjusted so that the jaws 51 and 52 compress the fibrous blank 100 in order to obtain a pre-compacted blank 100′. The spacing between the jaws 51 and 52 is thus adjusted so that the pre-compaction housing, defined between the base 53 and the jaws 51 and 52, has the shape of the reinforcing element to be obtained. The compression of the fibrous blank 100 can be enabled in particular by the different compaction capacities along the fibrous blank 100 along the first direction D₁. Thus, the thickness of the first portion 110 of the fibrous blank 100 along the third direction D₃ decreases more than the thickness of the second portion 120 of the fibrous blank 100 along the third direction D₃.

Preferably, the geometry and spacing of the jaws 51 and 52 during the are configured so as to produce a pre-compacted fibrous blank 100′ having a flared shape.

The pressure applied by the jaws 51 and 52 to the fibrous blank 100 allows to shape the surfaces to be profiled 105 and 106 so as to obtain profiled surfaces 105′ and 106′ of the pre-compacted fibrous blank 100′ in the desired shape. The pressure applied by the jaws 51 and 52 to the fibrous blank 100 allows to reduce the area of the reference surface 101 so as to obtain a pre-compacted reference surface 101′ of the pre-compacted fibrous blank 100′ in the desired shape. The pressure applied by the jaws 51 and 52 to the fibrous blank 100 allows to shape the lateral surfaces 102 and 104 so as to obtain pre-compacted lateral surfaces 102′ and 104′ of the pre-compacted fibrous blank 100′ in the desired shape.

The pre-compacted blank 100′ is then cut while it is still pre-compacted in the pre-compaction tool 5. The pre-compacted blank 100′ is preferably cut by water-jet cutting. The pre-compacted blank 100′ is cut along a cutting path T_{d}. The cutting path T_{d} comprises at least one portion T_{d3} allowing the removal of the raw surface 103 of the fibrous blank 100. Indeed, the raw surface 103 is removed while the fibrous blank is being pre-compacted in the pre-compaction tool 5. Cutting the fibrous blank 100 by removing the raw surface 103 allows to obtain a clean surface 103′ having the desired shape.

The cutting is preferably carried out along the free edges of the jaws 51 and 52. The trajectory of the water jet is preferably oriented along the third direction D₃, D₅₃. The water jet may have a feed rate comprised between 150 mm per minute and 250 mm per minute. The water jet may follow a rectilinear path T_{d3} along the second direction D₂, D₅₂ to remove the raw surface 103, as illustrated in FIG. 5. However, it does not depart from the scope of the invention if the cutting path for removing the raw surface 103 is non-rectilinear. For example, the cutting path for removing the raw surface 103 may have portions extending along the first direction D₁, D₅₁. The clean surface 103′ obtained by cutting the fibrous blank 100 may therefore have particular geometries adapted to the desired shape of the insert.

The cutting path Ta may also comprise at least one portion T_{d2} or T_{d4} allowing the removal of the raw lateral surface 102 or 104 of the fibrous blank 100. Indeed, the raw lateral surface(s) 102 or 104 may be removed while the fibrous blank is being pre-compacted in the pre-compaction tool 5. Cutting the fibrous blank 100 by removing the raw lateral surfaces 102 and 104 allows to obtain clean lateral surfaces 102′ and 104′ having the desired shape.

Performing the cutting while the blank is pre-compacted allows to achieve a flared pre-compacted blank geometry with a sudden variation in thickness, and with great precision.

The pre-compacted and cut fibrous blank 100′ is then removed from the pre-compaction tool 5, as illustrated in FIG. 6.

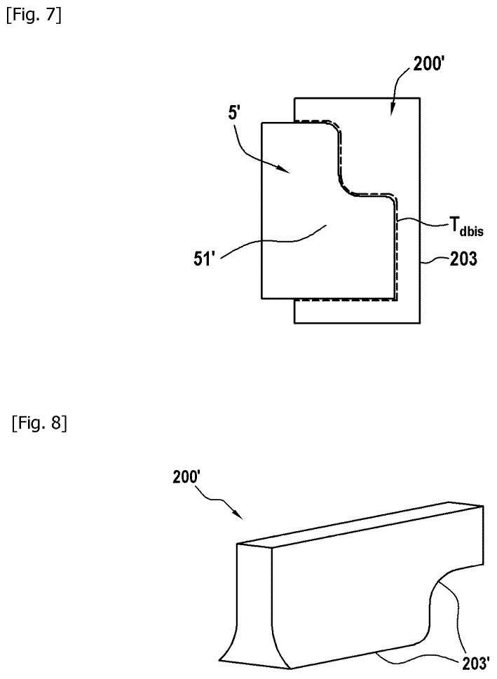

FIGS. 7 and 8 illustrate a variant in which the raw surface 203 of the pre-compacted fibrous blank 200′ is cut along a non-rectilinear cutting path T_{dbis} in the plane comprising the first and second directions, to obtain a clean surface 203′ with a complex geometry. The shape of the pre-compaction tool 5′, in particular the shape of the jaws 51′, is obviously adapted to allow cutting.

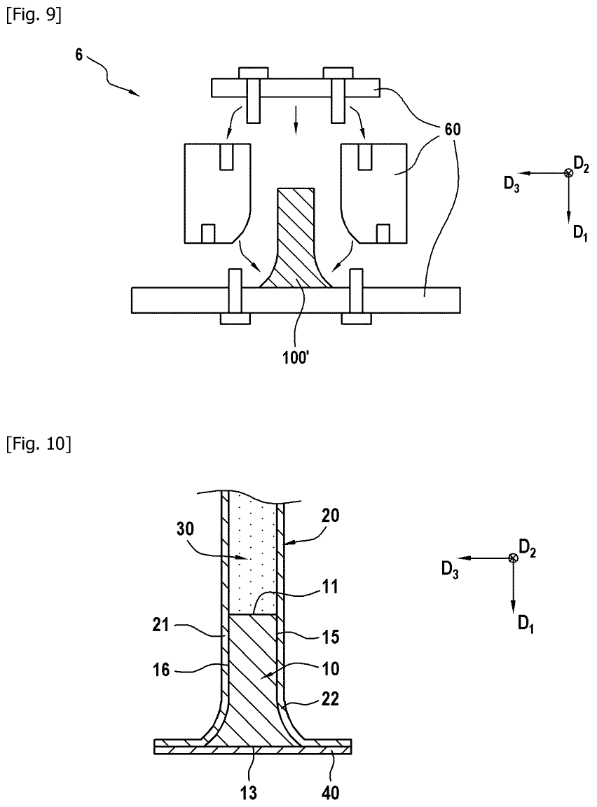

The pre-compacted and cut fibrous blank 100′ is then placed in a compaction tool 6, as illustrated in FIG. 9. Indeed, when the pre-compacted fibrous blank 100′ is extracted from the pre-compaction tool 5, it may re-expand and does not have the desired fiber volume ratio.

The compaction tool 6 is preferably composed of several blocks 60 configured to compact the pre-compacted and cut fibrous blank 100′. The compaction tool 6 is configured to compact the pre-compacted fibrous blank 100′ to the desired fiber volume ratio. The compaction tool 6 is configured to compact the pre-compacted fibrous blank 100′ so as to obtain a fiber volume ratio comprised between 50% and 70%. The compaction tool 6 is configured to compact the pre-compacted fibrous blank 100′ into a fibrous preform 10 of a reinforcing element. The fibrous preform 10 of the reinforcing element is intended to form the fiber reinforcement of the reinforcing element which will be densified by a matrix.

The compaction tool 6 can also perform a drying function. Thus, the fibrous preform 10 present in the compaction tool 10 can be subjected to one or more drying cycles. Thus, the step of compacting the pre-compacted fibrous blank 100′ into a fibrous preform 10 and the drying step can be carried out simultaneously. Then, the fibrous preform 10 placed in the compaction tool is cooled then cold-demolded. Thus, the fibrous preform 10 is solidified and rigid, even in the thinnest portions. The fibrous preform 10 obtained can have a flared shape with a sudden variation in thickness.

The fibrous preform 10 thus comprises a first end surface 11 having a small area, corresponding to the reference surface 101′ of the pre-compacted fibrous blank 100′, and a second end surface 13, opposite the first end surface 11, having a large area, corresponding to the clean surface 103′ of the pre-compacted fibrous blank 100′. The fibrous preform 10 also comprises two profiled surfaces 15 and 16 corresponding to the profiled surfaces 105′ and 106′ of the pre-compacted fibrous blank 100′.

The fibrous preform 10 of the reinforcing element is intended to be co-densified with at least one fibrous preform of the blade to obtain a blade made of composite material.

For this purpose, a fibrous preform of the blade 20 is produced in a well-known manner by weaving, comprising at least two skins 21 and 22 connected to each other at least at one end, for example by means of a delinking in the weaving separating said two skins 21 and 22. The two skins 21 and 22 of the blade preform 20 delimit there between a cavity opening onto an opening. The fibrous preform of the blade 20 can be produced entirely by three-dimensional weaving. The free end of the skins 21 and 22 of the blade preform 20 can be intended to form one or more platforms of the blade to be obtained. Preferably, the first skin 21 is intended to be located at the pressure side in the final blade and the second skin 22 is intended to be located at the suction side of the final blade.

As illustrated in FIG. 10, at least a part of the fibrous preform of the reinforcing element 10 is inserted into the cavity of the fibrous preform of the blade 20, such that the fibrous preform of the reinforcing element 10 fills the opening of said cavity. In particular, the first end surface 11 of the fibrous preform 10 is present in the cavity, while the second end surface 13 is present at the opening of the cavity of the blade preform 20.

The fibrous preform of the reinforcing element 10 may be inserted entirely into the cavity of the blade preform 20. The fibrous preform of the reinforcing element 10 may comprise a portion present outside the cavity of the blade preform 20.

According to a particular embodiment of the invention, before inserting the fibrous preform of the reinforcing element 10, at least one filling element 30 is inserted into the base of the cavity of the fibrous preform of the blade 20. In this configuration, the first end surface 11 of the fibrous preform 10 may be in contact with the filling element 30. The filling element has a lower density than the fibrous preforms 10, 20 and 30. The filling element 30 may be made of foam, for example a foam of organic origin (polyethacrylimide, polyethylene terephthalate (PET), polyvinyl chloride (PVC), polyetherimide (PEI), polyvinyl, carbon, polyisocyanurate, polyurethane, etc.). The filling element 30 may have a honeycomb structure.

According to a particular embodiment of the invention, compatible with the previous embodiment, a fibrous plate preform 40 can be arranged in contact with the second end surface 13 of the preform of the reinforcing element 10 and in contact with the two skins 21 and 22 of the blade preform, as illustrated in FIG. 10.

A set of fibrous preforms is thus obtained comprising the preform of the reinforcing element 10, the blade preform 20 and possibly the filling element(s) 30.

The height of the fibrous preform of the reinforcing element 10 may be greater than 3% of the total height of the set of preforms. In particular, the height of the fibrous preform of the reinforcing element 10 may be greater than 5% of the total height of the set of preforms, for example greater than 10% of the total height of the set of preforms. “Height of the fibrous preform of the reinforcing element” means the distance between the first end surface 11 and the portion of the second end surface 13 furthest from the first end surface 11. The height of the fibrous preform of the reinforcing element 10 may be less than 50% of the total height of the set of preforms. In particular, the height of the fibrous preform of the reinforcing element 10 may be less than 10% of the total height of the set of preforms. The height of the fibrous preform of the reinforcing element 10 may be comprised between 5% and 15% of the total height of the set of preforms. Thus, the fiber reinforcement will extend into the final blade over a sufficient distance to increase the stiffness of the root, but not too great in order to limit the mass of the blade to be obtained.

The set of fibrous preforms formed at least by the fibrous preform of the reinforcing element 10 and the fibrous preform of the blade 20 is then densified. The set of fibrous preforms can be placed in an injection mold having a molding cavity whose dimensions correspond substantially to the dimensions of the final blade to be produced.

The well-known injection or transfer molding method known as “RTM” (for “Resin Transfer Molding”) can be used. According to this method, a resin, for example a thermosetting resin, is injected via one or more injection ports into the molding cavity occupied by the set of preforms. The resin used can, for example, be an epoxy resin with a temperature class of 180° C. Resins suitable for RTM methods are well known. They preferably have a low viscosity to facilitate their injection into the fibers. The choice of the temperature class and/or the chemical nature of the resin is determined according to the thermomechanical stresses to which the blade must be subjected. Once the resin has been injected into the entire set of preforms, it is polymerized by heat treatment in accordance with the RTM method. After injection and polymerization, the blade is demolded. It may optionally undergo a post-curing cycle to improve its thermomechanical characteristics, for example to increase its glass transition temperature. Finally, the blade is trimmed to remove excess resin. Passages and counterbores can be machined, particularly at the blade root.

Optionally, a leading edge can be inserted. An outer layer forming the leading edge is then placed over the assembly to achieve the leading edge mating. Then, the leading edge is autoclaved to be bonded to the assembly.

A blade made of composite material is thus obtained, comprising a reinforcing element made of composite material, the fiber reinforcement of which is formed by the fibrous preform of the reinforcing element 10. The blade obtained is preferably made of organic matrix composite material. Indeed, organic matrix composite materials have good mechanical characteristics for a reduced mass. It is of course not outside the scope of the invention if the blade is densified in a well-known manner by a ceramic matrix, for example by means of a slip.

1. A method for manufacturing a fibrous preform of a reinforcing element for a blade, comprising:
producing a fibrous blank by three-dimensional weaving between a plurality of warp yarns extending in a first direction and a plurality of weft yarns extending in a second direction intersecting the first direction, the fibrous blank extending in the first direction between a reference surface and a raw surface, and extending in a third direction intersecting the first and second directions between two surfaces to be profiled,
removing the raw surface of the fibrous blank by water-jet cutting so as to produce a clean surface,
arranging the fibrous blank comprising the clean surface in a compaction tool in order to obtain a fibrous preform having the shape of the reinforcing element to be obtained and having a determined volumetric fiber content;
arranging the fibrous blank in a pre-compaction tool before removing the raw surface of said blank, the pre-compaction tool comprising a housing delimited by a base and two jaws extending from said base, a spacing between the two jaws being adjustable, the fibrous blank being arranged in the housing of the pre-compaction tool so that the reference surface of said blank is arranged in contact with the base, then
adjusting the two jaws of the pre-compaction tool so that the housing of the pre-compaction tool has the shape of the fibrous preform of the reinforcing element to be obtained in order to pre-compact the fibrous blank, the surfaces to be profiled of the blank being arranged in contact with the jaws and the raw surface of the fibrous blank being free,
the removing of the raw surface being carried out while the fibrous blank is being pre-compacted in the pre-compaction tool, and the pre-compacted fibrous blank being removed from the pre-compaction tool after the removing the raw surface before being arranged in the compaction tool.

2. The manufacturing method according to claim 1, wherein the fibrous blank is obtained by water-jet cutting in a fibrous strip produced by three-dimensional weaving at the outlet of a loom.

3. The manufacturing method according to claim 1, wherein the reference surface and the raw surface of the fibrous blank comprise the same number of warp yarns.

4. The manufacturing method according to claim 1, wherein the fibrous blank comprises a first portion extending from the reference surface having a compacting capacity greater than the compacting capacity of a second portion of the blank extending from the raw surface.

5. The manufacturing method according to claim 4, wherein the average diameter of the weft yarns of the second portion of the blank is larger than the average diameter of the weft yarns of the first portion of said blank.

6. The manufacturing method according to claim 1, wherein the water-jet cutting for removing the raw surface follows a non-rectilinear profile.

7. The manufacturing method according to claim 1, wherein the fibrous blank is arranged in the pre-compaction tool so that two raw lateral surfaces of the fibrous blank opposite in the second direction are free, the two raw lateral surfaces being removed by water-jet cutting while the fibrous blank is being pre-compacted in the pre-compaction tool.

8. A method for manufacturing a blade made of composite material comprising:
manufacturing a fibrous preform of a reinforcing element according to claim 1,
manufacturing a fibrous preform of the blade comprising at least two skins connected to each other at one end and delimiting there between a cavity opening into an opening,
inserting all or part of the fibrous preform of the reinforcing element into the cavity of the fibrous blank of the blade so as to fill the opening of said cavity,
densifying, by a matrix, the assembly formed by the fibrous preform of the reinforcing element arranged in the fibrous preform of the blade, so as to obtain a blade made of composite material comprising a reinforcing element.

9. The manufacturing method according to claim 8, wherein a filling element is inserted at the base of the cavity of the fibrous preform of the blade before the fibrous preform of the reinforcing element is inserted into said cavity.

10. The manufacturing method according to claim 8, wherein the blade is a stator blade, a rotor blade or a propeller blade.

11. A blade obtained by the manufacturing method according to claim 8, the thickness of the reinforcing element of the blade obtained increasing by at least 200% over a distance less than 50% of the height of said reinforcing element.

12. A turbine engine comprising at least one blade according to claim 11.
